(19) United States
(12) Patent Application Publication
(10) Pub. No.: US 2002/0121726 A1
(43) Pub. Date: Sep. 5, 2002

(54) Ceramic honeycomb extrusion apparatus and method of extruding ceramic honeycomb by utilizing such apparatus

(75) Inventors: Satoru Inoue, Hazu-Gun (JP); Kenji Yamada, Nagoya City (JP)

Correspondence Address: PARKHURST & WENDEL, L.L.P., 1421 PRINCE STREET, SUITE 210, ALEXANDRIA, VA, 22314-2805, US

(73) Assignee: NGK Insulators, Ltd., Nagoya City (JP)

(21) Appl. No.: 10/082,141

(22) Filed: Feb. 26, 2002

(30) Foreign Application Priority Data
Mar. 1, 2001 (JP) 2001-56,403

(51) Int. Cl. B29C 47/00

(52) U.S. Cl. 264/169; 264/177.12; 425/190; 425/198; 425/382.4; 425/461

(57) ABSTRACT

The flow regulation portion includes a diameter reducing portion, a cylinder portion and a diameter expanding portion arranged from an upstream side, wherein: (1) an inlet shape of the diameter reducing portion at a side of the biaxial screw portion is equal to an outlet shape of the biaxial screw portion; (2) an outlet shape of the diameter reducing portion at a side of the cylinder portion is equal to an inlet shape of the cylinder portion; (3) an inlet shape of the diameter expanding portion at a side of the cylinder portion is equal to an outlet shape of the cylinder portion; and (4) an outlet shape of the diameter expanding portion at a side of the foreign substance removal portion is equal to an inlet shape of the foreign substance removal portion. The flow regulation portion is formed by a cassette mechanism, thereby reducing a maintenance cost and a delivery date.

### BACKGROUND OF THE INVENTION

(1) Field of the Invention

The present invention relates to a ceramic honeycomb extrusion apparatus having a biaxial screw portion, a flow regulation portion, a foreign substance removal portion and an aglet extrusion portion, which are arranged as a main portion from an upstream side of a batch flow, and also relates to a method of extruding the ceramic honeycomb by utilizing such an apparatus.

(2) Prior Art Statement

As an extrusion apparatus for extruding a ceramic honeycomb, there is known a ceramic honeycomb extrusion apparatus having a biaxial screw portion, a flow regulation portion, a foreign substance removal portion and an aglet extrusion portion, which are arranged as a main portion from an upstream side of a batch flow. FIG. 4 is a schematic view showing one embodiment of a known ceramic honeycomb extrusion apparatus. In the embodiment shown in FIG. 4, a ceramic honeycomb extrusion apparatus 51 comprises a biaxial screw portion 52, a flow regulation portion 53, a foreign substance removal portion 54 and an aglet extrusion portion 55, which are arranged as a main portion from an upstream side of a batch flow. The foreign substance removal portion 54 comprises a foreign substance removal apparatus 61, an upstream connection portion 62 arranged at an upstream side of the foreign substance removal apparatus 61 and a down-stream connection portion 63 arranged at a downstream side of the foreign substance removal apparatus 61. The aglet extrusion portion 55 comprises a connection portion 64 and a die hold portion 65 to which a die is arranged. It should be noted that connections between respective portions are performed by means of flange, bolt, nut, screw and so on.

In the ceramic honeycomb extrusion apparatus 51, the flow regulation portion 53 has a cylinder shape having a constant diameter, but, an outlet shape of the biaxial screw portion 52 and an inlet shape of the flow regulation portion 53 are different, and, an outlet shape of the flow regulation portion 53 and an inlet shape of the upstream connection portion 62 of the foreign substance removal portion 54 are also different. Therefore, as shown in FIG. 5, there is a drawback such that batch suspend portions, in which a batch flow is suspended, are generated at portions (A) of the biaxial screw portion 52 and at portions (B) of the upstream connection portion 62. These batch suspend portions prevent a batch flow and generate heat, and thus there is a drawback such that it is not possible to extrude normal ceramic honeycombs particularly thin-wall ceramic honeycombs having a wall thickness of not more than 2 mil that are highly required in late years.

### SUMMARY OF THE INVENTION

An object of the present invention is to eliminate the drawbacks mentioned above and to provide a ceramic honeycomb extrusion apparatus and a method of extruding ceramic honeycomb by utilizing such apparatus, which can make a batch flow smooth and prevent a heat generation, so that normal thin-wall ceramic honeycombs can be extruded.

According to the invention, a ceramic honeycomb extrusion apparatus having a biaxial screw portion, a flow regulation portion, a foreign substance removal portion and an aglet extrusion portion, which are arranged as a main portion from an upstream side of a batch flow, comprises the construction such that the flow regulation portion includes a diameter reducing portion, a cylinder portion and a diameter expanding portion arranged from an upstream side, wherein:

(1) an inlet shape of the diameter reducing portion at a side of the biaxial screw portion is equal to an outlet shape of the biaxial screw portion;

(2) an outlet shape of the diameter reducing portion at a side of the cylinder portion is equal to an inlet shape of the cylinder portion;

(3) an inlet shape of the diameter expanding portion at a side of the cylinder portion is equal to an outlet shape of the cylinder portion; and

(4) an outlet shape of the diameter expanding portion at a side of the foreign substance removal portion is equal to an inlet shape of the foreign substance removal portion.

Moreover, according to the invention, a method of extruding a ceramic honeycomb, comprising a step of extruding the ceramic honeycomb by utilizing the ceramic honeycomb extrusion apparatus mentioned above.

In the present invention, since the flow regulation portion includes a diameter reducing portion, a cylinder portion and a diameter expanding portion arranged from an upstream side, wherein: (1) an inlet shape of the diameter reducing portion at a side of the biaxial screw portion is equal to an outlet shape of the biaxial screw portion; (2) an outlet shape of the diameter reducing portion at a side of the cylinder portion is equal to an inlet shape of the cylinder portion; (3) an inlet shape of the diameter expanding portion at a side of the cylinder portion is equal to an outlet shape of the cylinder portion; and (4) an outlet shape of the diameter expanding portion at a side of the foreign substance removal portion is equal to an inlet shape of the foreign substance removal portion, batch suspend portions generated at both ends of the flow regulation portion can be prevented, and thus it is possible to extrude normal thin-wall ceramic honeycombs.

As a preferred embodiment of the present invention, the flow regulation portion has a cassette mechanism such that only an inner portion thereof can be attached or detached, or, the cassette mechanism of the flow regulation portion is formed by assembling at least two members. In these embodiments, only wear portions among the flow generation portion can be exchanged, and thus it is possible to reduce a maintenance fee of the ceramic honeycomb extrusion apparatus. Therefore, there are preferred embodiments.

### BRIEF DESCRIPTION OF THE DRAWING

For a better understanding of the present invention, explanations are made to the following drawings wherein:

FIG. 1 is a schematic view showing one embodiment of a ceramic honeycomb extrusion apparatus according to the invention;

FIG. 2a is a schematic view that views a flow regulation portion from a biaxial screw portion side and FIG. 2b is a schematic view that views the flow regulation portion from a foreign substance removal portion side;

FIGS. 3a-3d are schematic views respectively illustrating one embodiment of the flow regulation portion of the ceramic honeycomb extrusion apparatus according to the invention;

FIG. 4 is a schematic view depicting one embodiment of a known ceramic honeycomb extrusion apparatus; and

FIG. 5 is a schematic view for explaining drawbacks of the known ceramic honeycomb extrusion apparatus.

### DESCRIPTION OF THE PREFERRED EMBODIMENTS

FIG. 1 is a schematic view showing one embodiment of a ceramic honeycomb extrusion apparatus according to the invention. In the embodiment shown in FIG. 1, a ceramic honeycomb extrusion apparatus 1 according to the invention comprises a biaxial screw portion 2, a flow regulation portion 3, a foreign substance removal portion 4 and an aglet extrusion portion 5, which are arranged as a main portion from an upstream side of a batch flow. The foreign substance removal portion 4 comprises a foreign substance removal apparatus 11, an upstream connection portion 12 arranged at an upstream side of the foreign substance removal apparatus 11 and a downstream connection portion 13 arranged at a downstream side of the foreign substance removal apparatus 11. The aglet extrusion portion 5 comprises a connection portion 14 and a die hold portion 15 to which a die is arranged. The construction mentioned above is the same as that of the known ceramic honeycomb extrusion apparatus. It should be noted that connections between respective portions are performed by means of flange, bolt, nut, screw and so on.

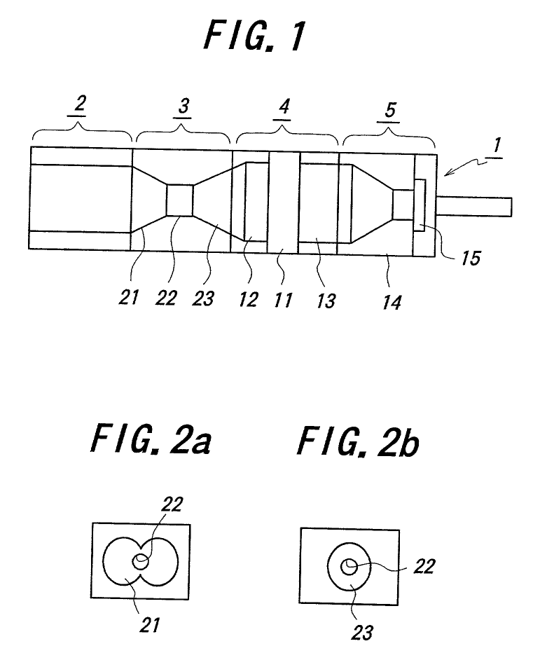

Features of the ceramic honeycomb extrusion die 1 according to the invention are as follows: the flow regulation portion 3 includes a diameter reducing portion 21, a cylinder portion 22 and a diameter expanding portion 23 arranged from an upstream side, wherein: (1) an inlet shape of the diameter reducing portion 21 at a side of the biaxial screw portion 2 is equal to an outlet shape of the biaxial screw portion 2; (2) an outlet shape of the diameter reducing portion 21 at a side of the cylinder portion 22 is equal to an inlet shape of the cylinder portion 22; (3) an inlet shape of the diameter expanding portion 23 at a side of the cylinder portion 22 is equal to an outlet shape of the cylinder portion 22; and (4) an outlet shape of the diameter expanding portion 23 at a side of the foreign substance removal portion 4 is equal to an inlet shape of the foreign substance removal portion 4 (in this embodiment, an inlet shape of the upstream connection portion 12 of the foreign substance removal portion 4). FIG. 2a is a schematic view that views the flow regulation portion 3 from the biaxial screw portion 2 side and FIG. 2b is a schematic view that views the flow regulation portion 3 from the foreign substance removal portion 4 side.

In this manner, since the flow regulation portion 3 is constructed by means of the diameter reducing portion 21, the cylinder portion 22 and the diameter expanding portion 23, it is possible to eliminate batch suspend portions generated at both ends of the flow regulation portion 3 and to prevent heat generation, so that normal ceramic honeycombs can be extruded.

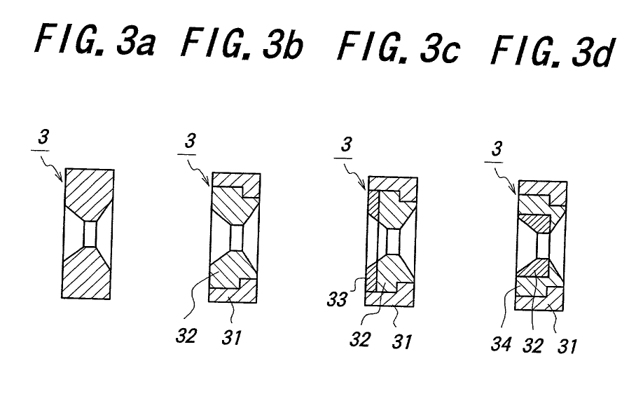

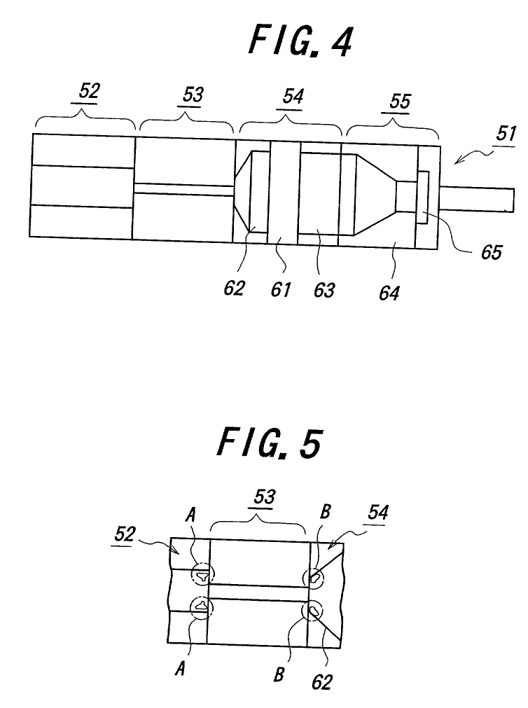

Then, a construction of the flow regulation portion 3 according to the invention will be explained. FIGS. 3a-3d are schematic views respectively showing one embodiment of the flow regulation portion 3 of the ceramic honeycomb extrusion apparatus 1 according to the invention. In the embodiment shown in FIG. 3a, the diameter reducing portion 21, the cylinder portion 22 and the diameter expanding portion 23 are integrally constructed. This construction is the same as that of the embodiment shown in FIG. 1. In this embodiment, except for this construction, it is possible to construct the flow regulation portion 3 having a cassette mechanism such that only an inner portion thereof can be attached or detached, and more specifically it is possible to form the cassette mechanism of the flow regulation portion 3 by assembling at least two members as shown in FIGS. 3b-3d.

That is, in the embodiment shown in FIG. 3b, the flow regulation portion 3 having the diameter reducing portion 21, the cylinder portion 22 and the diameter expanding portion 23 is constructed by two members of an outer member 31 and an inner member 32. These two members are fixed with each other by means of key-pin/key-slot, fitting construction, screw cramp and so on. In the embodiment shown in FIG. 3c, the flow regulation portion 3 is constructed by three members of the outer member 31, the inner member 32 and an end member 33 that can be assembled by sliding laterally. These three members are fixed with each other by means of key-pin/key-slot, fitting construction, screw cramp and so on. In the embodiment shown in FIG. 3d, the flow regulation portion 3 is constructed by three members of the outer member 31, the inner member 32 and an intermediate member 34. These three members are fixed with each other by means of key-pin/key-slot, fitting construction, screw cramp and so on.

As shown in FIGS. 3b-3d, since the flow regulation portion 3 is constructed by assembling two or more members so as to realize detachable cassette mechanism, only the were portion of the flow regulation portion 3 to which batch is contacted i.e. only the inner member 32 or the end member 34 in the embodiments shown in FIGS. 3b-3d can be exchanged, and thus it is possible to reduce a maintenance cost of the ceramic honeycomb extrusion apparatus 1 according to the invention. Therefore, these embodiments are preferable. Here, it should be noted that the embodiments shown in FIGS. 3b-3d are respectively one example for dividing the flow regulation portion 3 and thus various methods and numbers other than those of these embodiments for dividing the flow regulation portion 3 can be applied. For example, in FIG. 2d, it is possible to form this construction by means of two members by integrating the intermediate member 34 and the outer member 31. Moreover, it is a matter of course that an outer diameter of the inner member and the end member must be made larger than a screw inner diameter of the biaxial screw portion. If such an outer diameter is not larger than the screw inner diameter of the biaxial screw portion, the outer member and the intermediate member are worn and thus it is meaningless to exchange only the worn inner member and the worn end member.

As clearly understood from the above explanations, according to the invention, since the flow regulation portion includes a diameter reducing portion, a cylinder portion and a diameter expanding portion arranged from an upstream side, wherein: (1) an inlet shape of the diameter reducing portion at a side of the biaxial screw portion is equal to an outlet shape of the biaxial screw portion; (2) an outlet shape of the diameter reducing portion at a side of the cylinder portion is equal to an inlet shape of the cylinder portion; (3) an inlet shape of the diameter expanding portion at a side of the cylinder portion is equal to an outlet shape of the cylinder portion; and (4) an outlet shape of the diameter expanding portion at a side of the foreign substance removal portion is equal to an inlet shape of the foreign substance removal portion, batch suspend portions generated at both ends of the flow regulation portion can be prevented, and thus it is possible to extrude normal thin-wall ceramic honeycombs. Moreover, since the flow regulation portion is formed by the detachable cassette mechanism, exchanging parts of the flow regulation portion can be made small and thus a maintenance cost, a man-hour and a delivery date of the flow regulation portion can be reduced.

What is claimed is:

1. A ceramic honeycomb extrusion apparatus having a biaxial screw portion, a flow regulation portion, a foreign substance removal portion and an aglet extrusion portion, which are arranged as a main portion from an upstream side of a batch flow, comprising the construction such that the flow regulation portion includes a diameter reducing portion, a cylinder portion and a diameter expanding portion arranged from an upstream side, wherein:
(1) an inlet shape of the diameter reducing portion at a side of the biaxial screw portion is equal to an outlet shape of the biaxial screw portion;
(2) an outlet shape of the diameter reducing portion at a side of the cylinder portion is equal to an inlet shape of the cylinder portion;
(3) an inlet shape of the diameter expanding portion at a side of the cylinder portion is equal to an outlet shape of the cylinder portion; and
(4) an outlet shape of the diameter expanding portion at a side of the foreign substance removal portion is equal to an inlet shape of the foreign substance removal portion.

2. The ceramic honeycomb extrusion apparatus according to claim 1, wherein the flow regulation portion has a cassette mechanism such that only an inner portion thereof can be attached or detached.

3. The ceramic honeycomb extrusion apparatus according to claim 2, wherein the cassette mechanism of the flow regulation portion is formed by assembling at least two members.

4. A method of extruding a ceramic honeycomb, comprising a step of extruding the ceramic honeycomb by utilizing the ceramic honeycomb extrusion apparatus set forth in claim 1.
